(19) United States
(12) Patent Application Publication
(10) Pub. No.: US 2015/0324790 A1
(43) Pub. Date: Nov. 12, 2015

(54) MESSAGING-BASED PAYMENTS

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/274,488

(22) Filed: May 9, 2014

(51) Int. Cl. G06Q 20/38

(52) U.S. Cl. CPC G06Q 20/382

(57) ABSTRACT

Embodiments for messaging-based payments are described. A messaging-based payment system (MBP) may be configured to facilitate payments between parties based via a messaging protocol, such as a text messaging protocol. The MBP may be configured to receive a request via the messaging protocol for a payment to be made from a first party to a second party. The request may include a payment amount as well as identifying information for the party making payment. In response to receipt of the request, the MBP may request an authorization of the payment from the first party. The request for authorization may be performed via the messaging protocol. After receiving authorization for the payment, the MBP may facilitate the requested payment from the first party to the second party. Payment may be made to an account of the second party or through a payment facilitator. Other embodiments may be described and claimed.

### TECHNICAL FIELD

The present disclosure relates to the field of data processing, in particular, to apparatuses, methods and storage media associated with facilitating payments through messaging.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Parties engage in financial transactions, and in particular transactions involving payment, every day. However, it is sometimes difficult for paid parties to easily accept non-cash payments. This is particularly true in cases where vendors (for goods and/or services) do not have resources easily at hand for taking such non-cash payments. For example, a vendor that sells goods only occasionally, such as at a farmer's market or flea market, may not need to want to contract with a credit card processor, and to pay attendant processor fees, when the vendor does not have a constant use for the processing service. Additionally, vendors may not have equal access to credit/debit/checking accounts to facilitate interaction with traditional credit or debit processing techniques. This can cause difficulty for vendors to accept non-cash payments, and can likewise frustrate potential customers that may wish to make non-cash payments with these vendors.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for messaging-based payment facilitation, in accordance with various embodiments.

FIG. 2 illustrates an example process for messaging-based payment facilitation, in accordance with various embodiments.

FIG. 3 illustrates an example process for setting up messaging-based payment facilitation, in accordance with various embodiments.

FIG. 4 illustrates an example process for receiving a payment request, in accordance with various embodiments.

FIG. 5 illustrates an example process for confirming authorization of a payment, in accordance with various embodiments.

FIG. 6 illustrates an example process for facilitating issuance of a payment, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. The term “messaging” as used herein may include instant messaging, personal messaging, text messaging, email, and so forth. Text messages may include messages sent using, e.g., short messaging service (SMS), or messages containing image, video, and sound content, e.g., multi-media messaging service (MMS).

In various embodiments, methods, systems, apparatuses, devices, and computer-readable media directed to messaging-based payments are described. In various embodiments, a messaging-based payment system (MBP) may be configured to facilitate payments between parties based via a messaging protocol, such as a text messaging protocol. The MBP may be configured to receive a request via the messaging protocol for a payment to be made from a first party to a second party. The request may be sent from the second party (the party receiving payment) and may include a payment amount as well as identifying information for the first party (the party making payment). For example, a vendor may send a text message to the MBP to request payment from a customer. The text message may include a payment amount, a credit card number, and a phone number for the customer. In other examples, the text message may include only the payment amount and the credit card number of the customer, or only the payment amount and the phone number of the customer. In another example, the customer may send a text message to the MBP to initiate a payment to a vendor.

In response to receipt of the request for payment, the MBP may verify that the requesting party (for example, the vendor) has an account with the MBP. The MBP may also request an authorization of the payment from the first party. In various embodiments, the request for authorization may be performed via the messaging protocol (or another messaging protocol) as used in the request for payment. In various embodiments, after receiving authorization for the payment, the MBP may facilitate the requested payment from the first party to the second party. In various embodiments, funds for the payment may be taken from various accounts of the first party, such as checking accounts, debit accounts, and/or credit accounts. In various embodiments, payment may be made to the second party, such as to an account of the second party. In some embodiments, payment may be made through a payment facilitator, such as a wire payment service, which may be facilitated in generating a check or other wire payment to the second party. In various embodiments, multiple payments may be held and delivered once an issuance threshold, such as a time- or amount-based threshold is reached.

In various embodiments, the messaging-based payment techniques described herein may provide for easier conducting of transaction between parties. For example, by providing facility for requesting a payment through a frequently available interface, such as messaging, the second party may be facilitated in receiving payments in a manner that is easier and/or cheaper than by using more traditional credit card processing systems. Additionally, by utilizing messaging for both request and authorization, the MBP may facilitate payment by not requiring special applications, hardware, or other equipment or resources than are commonly available to vendors and customers. Finally, by providing for payment through payment facilitators, such as wire payment services, a vendor may be allowed to receive payments without enforcing a requirement that the vendor utilize a checking or other account for payment receipt. Other benefits of the techniques described herein may be described below.

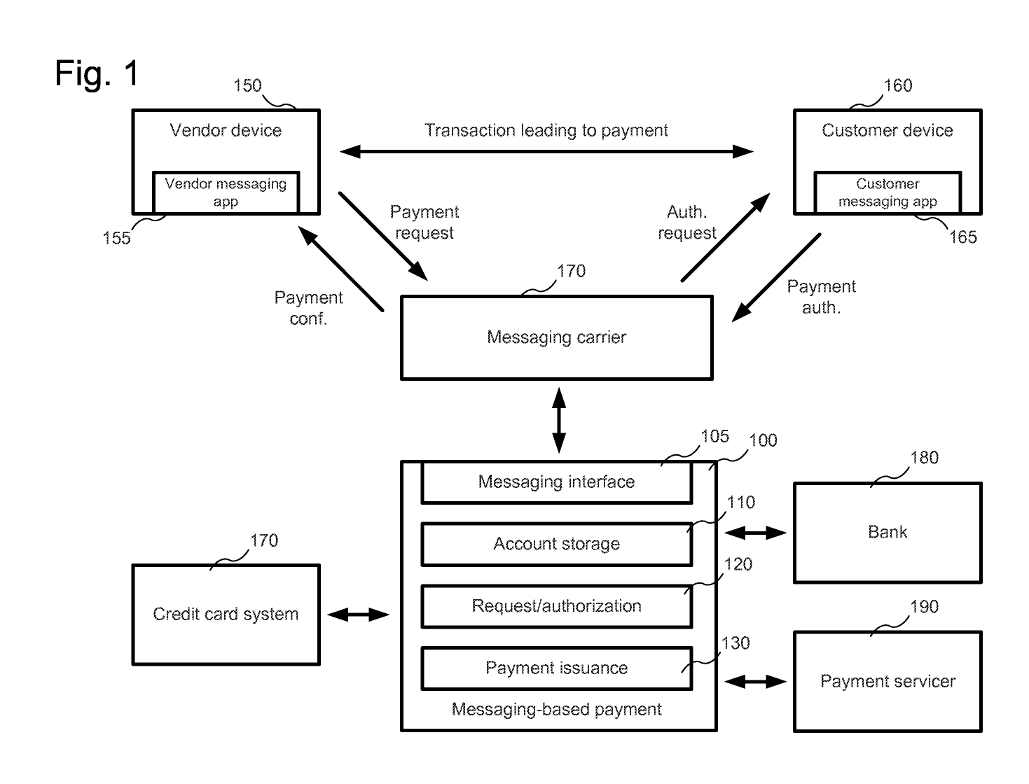

Referring now to FIG. 1, an example arrangement for messaging-based payment facilitation may be illustrated in accordance with various embodiments. It may be noted that, in various embodiments the terms “vendor” and “customer” are used to describe a party requesting payment and a party making payment, respectfully. In various embodiments, however, no particular requirements may be made on the type of activity being performed by parties utilizing the MBP to facilitate messaging-based payments. It may also be noted that, while particular entities and information flows are illustrated in FIG. 1, in various embodiments, entities and modules may be omitted, split into further entities or modules, or combined, and that other information may be sent between entities.

In various embodiments, a messaging-based payment system 100 (MBP 100) may be configured to communicate with a vendor device 150 and a customer device 160 via one or more messaging protocols. In various embodiments, the vendor device 150, customer device 160, and/or MBP 100 may include one or more computing devices and/or computing systems, including desktop computers, laptop computers, mobile phones, tablet computers, and/or other mobile or non-mobile devices. In various embodiments, payment may be requested in following a transaction that has been performed between the vendor and the customer. While this is illustrated, for the sake of convenience in the FIG. 1 as interaction between the vendor device 150 and the customer device 160, in various embodiments, it may be recognized that the actual transaction may be performed with or without the use of the one or more of the vendor device 150 and the customer device 160.

In various embodiments, the communication may sent and received by respective vendor messaging application 155 and customer messaging application 165 and/or a messaging interface 105 of the MBP 100. In various embodiments, a messaging carrier 170 may be configured to communicate with the vendor messaging application 155 and customer messaging application 165 and/or a messaging interface 105 to mediate messages. Such messaging may be performed with reference to a communication address for a party being messaged (such as a vendor, customer, or the MBP 100 itself). For example, in various embodiments, one or more communications may be performed via a text messaging protocol, such as a short message service (SMS) or multimedia messaging service (MMS). In such embodiments, the messaging carrier may include a wireless telephony carrier and the communication address may be a phone number for the vendor, customer, or MBP 100. In other embodiments, the vendor messaging application 155, customer messaging application 165, and/or messaging carrier 170 may be configured to mediate messages sent over a different messaging protocol, such as iMessage™.

In various embodiments, the MBP 100 may be configured to receive a payment request from the vendor messaging application 155 of the vendor device. In various embodiments, the payment request may be sent from the VMA 155 of the vendor device 150 via a messaging protocol mediated by the messaging carrier 170. In various embodiments, the payment request may include a payment amount, as well as identifying information for the customer, such as credit card, debit, or checking account information and/or a phone number for the customer. In various embodiments, the MBP 100 may be configured, in response to receipt of the request, to request authorization of the payment from the customer. This authorization request may, in various embodiments, be sent to the CMA 165 of the customer device 160 via a messaging protocol mediated by the messaging carrier 170. The MBP 100 may be configured to then send confirmation of the payment to the vendor, such as through another message using a messaging protocol.

In various embodiments, the MBP 100 may additionally or alternatively be configured to receive an authorization message from the CMA 165 of the customer device 160, and, in response to facilitate issuance of payment from the customer to the vendor. While many of the examples provided herein are provided with reference to a request made from the vendor, using the vendor device 150, it may be recognized that payment requests may be made by the customer from the customer device 160 in many embodiments.

In various embodiments, the MBP 100 may include an account storage 110 (AS 110), which may be configured to store information about various persons, including, but not limited to, vendors who may be paid and customers who may pay. In various embodiments, the AS 110 may be located internally or externally to the MBP 100, and may include various techniques and implementations, as may be understood. In various embodiments, the AS 110 may include information about a vendor, such as communication address/phone number information for the vendor device 150 (such as to identify a vendor when receiving a payment request), debit or credit account information, payment service information, etc. In various embodiments, the AS 110 may also include information about a customer, such as communication address/phone number information for the customer device 160 (such as to identify a customer from a payment request), debit or credit account information, etc. Additionally, in some embodiments, the AS 110 may be configured to hold information about accounts internal to the MBP 100. For example, as described below, in some circumstances, payments may be held until a particular issuance threshold is reached. In such embodiments, the AS 110 may be configured to hold one or more held amounts for a vendor until time is reached to make a payment. Additionally, in various embodiments, the AS 110 may also be configured to perform account setup operations, such as those described below.

In various embodiments, the MBP 100 may include one or more modules for performing techniques described herein. in various embodiments, the MBP 100 may include a request/authorization module 120 (RA 120), which may be configured to respond to receipt of a payment request from the VMA 155 of the vendor device 150 to initiate a payment process and to report back to the vendor with a payment confirmation when the payment is complete. The RA 120 may also be configured, in various embodiments, to request authorization of a payment from a customer, such as through messaging to the customer via the CMA 165 of the customer device 160 and to receive an authorization message in response. Techniques for conducting payment request receipt and authorization may be described below.

In various embodiments, the MBP 100 may include a payment issuance module 130 (PI 130). In various embodiments, the PI 130 may be configured to interact with one or more payment entities, such as a credit card system 170, a bank 180, and or a payment servicer 190. In various embodiments, the PI 130 may be configured to request debit and/or credit of one or more accounts, such as debit accounts, credit accounts, checking accounts, savings accounts, etc., which may be controlled by one or more of the credit card system 170 and/or bank 180. In other embodiments, the PI 130 may be configured to request the generation of a payment from a payment servicer 190. In various embodiments, payment servicers may include wire transfer entities, such as Western Union™, or other servicers. In some embodiments, payment servicers may be utilized when credit or other accounts are not available to or desired by the vendor. in such embodiments, the PI 130 may direct the generation of a check or cash payment from the payment service. In some embodiments, the check or cash payment may be generated in response to each payment request from the vendor or may be performed on a less frequent basis, such. For example, payment generation may be request when a particular time-based issuance threshold has been reached (for example at the end of a day or a week) or when a particular amount has been requested (for example, once $300 in total payments has been reached for the vendor). Particular techniques for issuing payment may be described below.

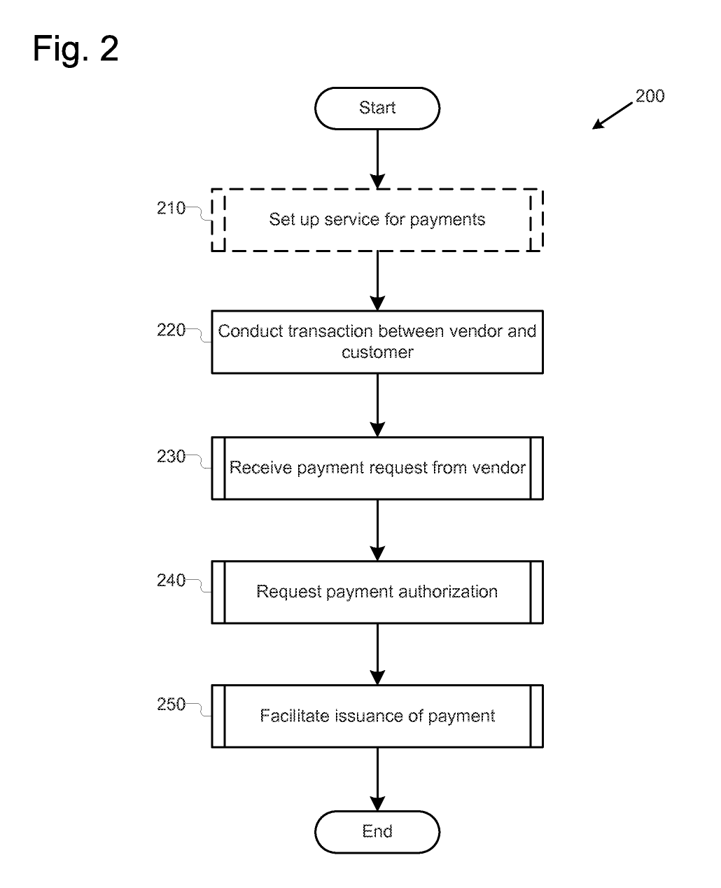

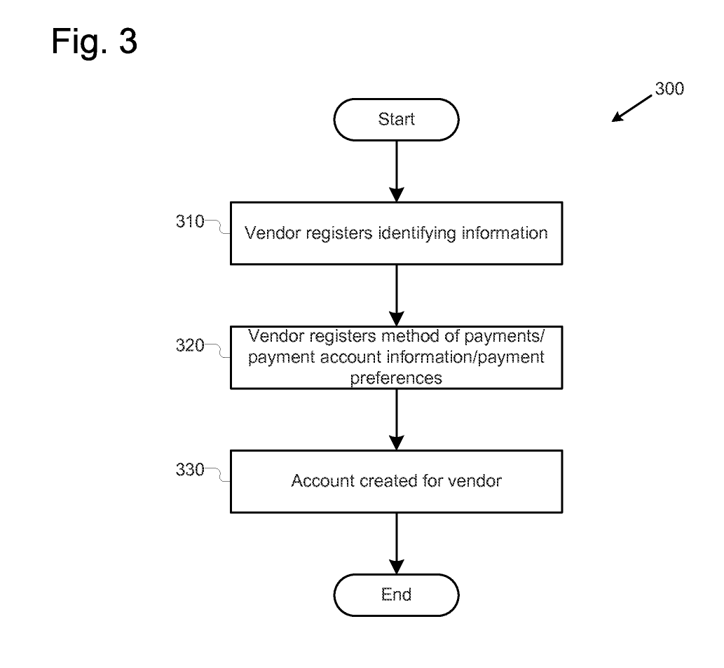

Referring now to FIG. 2, an example process for messaging-based payment facilitation is illustrated in accordance with various embodiments. While FIG. 2 illustrates particular operations in a particular order, in various embodiments, the operations may be combined, split into parts, and/or omitted. The process may begin at operation 210, where the vendor and/or customer may, in association with the AS 110, set up service to receive and/or make payments, respectively. In various embodiments, operation 210 may not be performed for every payment is made, but instead may be performed prior to issuance of payments. Particular examples of operation 210 may be described below with reference to process 300 of FIG. 3. Next, at operation 220, the customer and vendor may conduct a transaction. In various embodiments, various types of transactions may be performed without restriction on the techniques described herein. For example, transactions may include a purchase of goods, a contract for services, a gift from one party to another, etc.

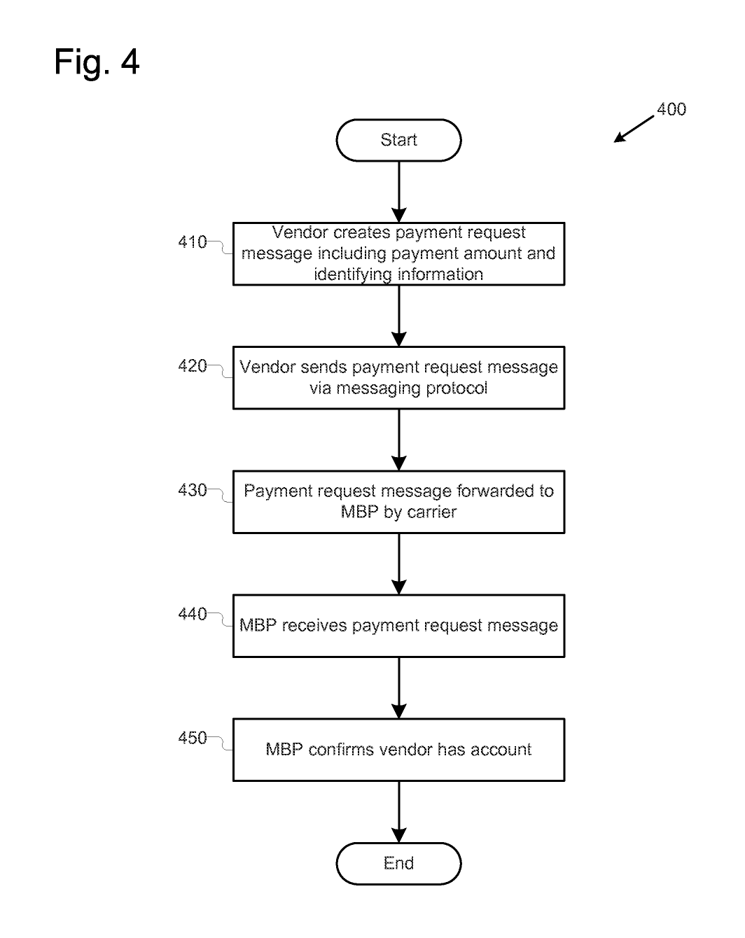

Next, at operation 230, the RA 120 may receive a payment request from the vendor. For example, the vendor may send a text message to the MBP 100 using the VMA 155 of the vendor device 150, which may be received and processed by the RA 120. Particular examples of operation 230 may be described below with reference to process 400 of FIG. 4. It may be noted that, in other embodiments, the RA 120 may receive the payment request from the customer instead.

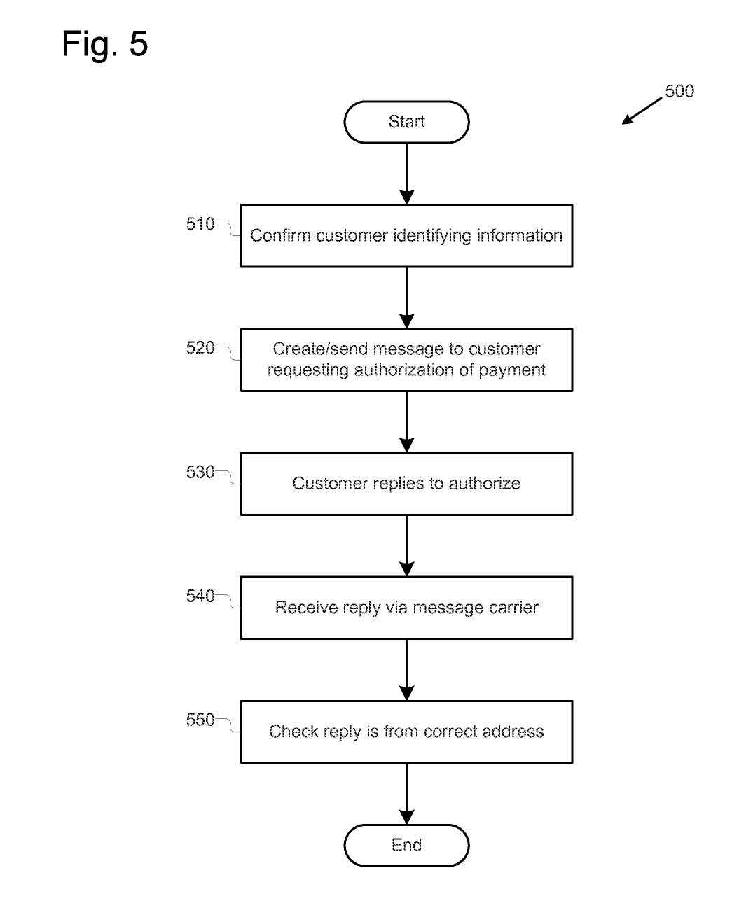

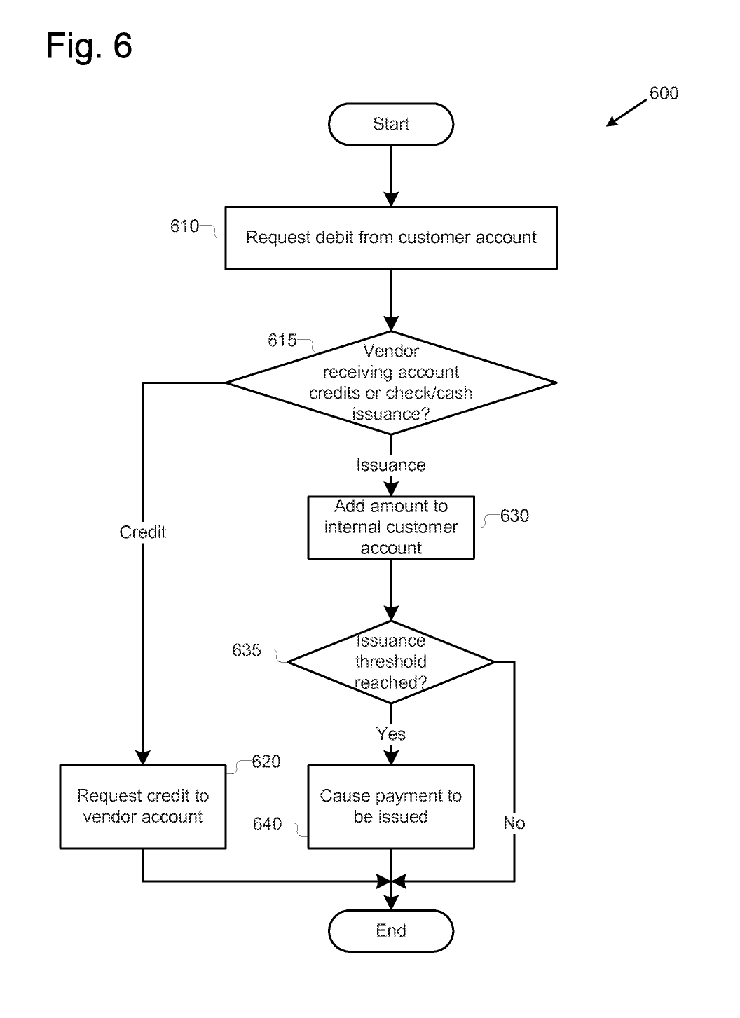

Next, at operation 240, the RA 120 of the MBP 100 may request authorization of the payment from the customer. For example, the RA 120 may send a text message requesting authorization of the payment to the CMA 165 of the customer device 160. Particular examples of operation 240 may be described below with reference to process 500 of FIG. 5. Next, at operation 250, the PI 130 may facilitate issuance of the requested and authorized payment. Particular examples of operation 250 may be described below with reference to process 600 of FIG. 6. Process 200 may then end.

Referring now to FIG. 3, an example process 300 for setting up messaging-based payment facilitation is illustrated in accordance with various embodiments. While FIG. 3 illustrates particular operations in a particular order, in various embodiments, the operations may be combined, split into parts, and/or omitted. In various embodiments, the operations described in process 300 may be performed as one or more implementations of operation 210 of process 200. The process may begin at operation 310, where the vendor may register identifying information with the AS 110. In various embodiments, the identifying information may include communication addresses, such as phone numbers, IP addresses, email addresses, etc., that facilitate the MBP 100 in recognizing the identity of the vendor when he or she makes a payment request.

Next, at operation 320, the vendor may register one or more methods by which the vendor may receive payment. For example, in some embodiments, the vendor may register financial account information, such as credit, debit, checking, and/or savings account information where the vendor may receive payments. In other embodiments, the vendor may register a preference to receive payments at a payment servicer, such as a wire transfer entity. In some embodiments, the vendor may register a particular servicer, such as one that is physically located in a convenient location.

In some embodiments, the vendor may also provide payment preferences at operation 320. For example, the vendor may register a preference that a payment above (or below) a predetermined amount should be made to a particular account. In other embodiments, at operation 320 the vendor may register a preference of when payment should be made from a payment servicer. For example, in some embodiments, the vendor may tell the MBP 100 to only cause issuance of a payment at the end of a work day (so the vendor can go to the servicer and receive a day's worth of payments at the end of the day). In another example, the vendor may tell the MBP 100 to only cause issuance of a payment when a particular total amount of payments has been received. This total amount may, in some embodiments, be calculated over multiple payments, and even over multiple customers. After registration of payment methods/account information, and/or payment preferences, at operation 330, the AS 110 may create an account for the vendor (or update an account if the account had previously been created). The process may then end.

It may be noted that, in the example of FIG. 3, operations are described with reference to the vendor; in other embodiments, the customer may be facilitated by the AS 110 of the MBP 100 in performing similar operations, such as registering identifying information for the customer (such as phone numbers or other communication addresses) and or registration of payment information/preferences.

Referring now to FIG. 4, an example process 400 for receiving a payment request is illustrated in accordance with various embodiments. While FIG. 4 illustrates particular operations in a particular order, in various embodiments, the operations may be combined, split into parts, and/or omitted. In various embodiments, the operations described in process 400 may be performed as one or more implementations of operation 230 of process 200. The process may begin at operation 410, where the vendor may create a payment request message. In various embodiments, the vendor request message may be created using the VMA 155 of the vendor device 150. In various embodiments, the vendor request message may include only text, or may include additional audio, video, and or images.

In various embodiments, the payment request message may include a payment amount for the requested payment. In various embodiments, the payment request message may also include identifying information for the customer from which payment is requested. For example, in some embodiments, the identifying information may include a credit card number for the customer (such as a credit card physically presented to the vendor as part of the transaction). In another example, the identifying information may include a phone number for the customer.

In addition to the payment amount and identifying information, in some embodiments, the vendor may include in the payment request message additional data that facilitates issuance of the payment. For example, in some embodiments, the vendor may include an indication of a preferred method of payment and/or an account at which the vendor wishes to receive payment. In other embodiments, the vendor may include a password, or other proof of identity, in order to avoid fraudulent payments being made to the vendor's account.

Next, after the vendor creates the payment request message, the vendor may send the created payment request message to the MBP 100 via the messaging protocol. In various embodiments, the vendor may have knowledge of a phone number or other communication address of the MBP 100 in order to send the payment request message. Next, at operation 430, the payment request message may be forwarded to the MBP 100 by the messaging carrier 170, and the MBP 100 (and in particular the messaging interface 105) and the MBP 100 may receive the payment request message at operation 440.

After receiving the payment request message, at operation 450, the MBP 100, and in particular RA 120, may confirm that the vendor has an account registered with the AS 110 of the MBP 100. In various embodiments, at operation 450, the RA 120 may confirm that the vendor has an account based on information received in the payment request message. In some embodiments, the RA 120 may be configured to look up an account for the vendor based on a phone number or other commination address of the vendor. For example, if the vendor sends a payment request message as a text message, the RA 120 may confirm the vendor account based on the phone number from which the payment request message was sent. In other embodiments, the RA 120 may confirm an account for the vendor based on security information, such as a password provided by the vendor in the payment request message. After issuance of operation 450, the process may end.

As discussed above, in alternative embodiments, the payment request may be created by the customer and sent from the customer device 160. In such embodiments, the payment request may include identifying information about the vendor, rather than about the customer, as well as payment information, such as the customer's credit card number. Other embodiments described herein may operate in similar manners to those described herein while operating based on the customer-generate payment request.

Referring now to FIG. 5, an example process 500 for receiving a payment request is illustrated in accordance with various embodiments. While FIG. 5 illustrates particular operations in a particular order, in various embodiments, the operations may be combined, split into parts, and/or omitted. In various embodiments, the operations described in process 500 may be performed as one or more implementations of operation 240 of process 200. The process may begin at operation 510, where the RA 120 may confirm the identifying information of the customer that was received in the payment request message in order that the payment may be authorized. For example, if the payment request message contains only a credit card number (or other financial information), the RA 120 may confirm that a phone number (or other communication address) for the customer is known to the AS 110 of the MBP 100, in order that the customer may be contacted for authorization. In another embodiment, where both a communication address and a credit card number (or other financial information) are received in the payment request message, the RA 120 may not need to confirm any additional information and may proceed with the information received in the request. In embodiments where the payment request is sent by the customer, the RA 120 may confirm the identity of the customer based on a phone number or other communication address from which the payment request was sent.

Next, at operation 520, the RA 120 may create and send an authorization message to the customer requesting authorization of the requested payment. In various embodiments, the RA 120 may send the message to the phone number or communication address that was received in the payment request message (or known to the AS 110 and confirmed at operation 510). In various embodiments, the authorization message may include information regarding the requested payment, such as, for example, payment amount, vendor identity, transaction information, etc. in order that the customer may understand the payment request and provide informed authorization. In other embodiments, the authorization message may also include instructions for replying to the authorization message, such as instructions that the customer may reply with a particular command (e.g., “Authorized” or “Pay”) in order to authorize the requested payment.

Next, at operation 530, the customer may reply to the authorization message to authorize the requested payment. In various embodiments, the customer may reply per instructions provided in the authorization message. In various embodiments, the reply may be made to the communication address from which the authorization message was sent (e.g., a communication address for the MBP 100). Next, at operation 540, the messaging interface 105 of the MBP 100 may receive the reply. At operation 550, the RA 120 may check that the reply is from the same communication address to which the authorization message was originally sent. In various embodiments, the check at operation 550 may help provide security to the customer by better ensuring that authorization for the payment is not faked by another party, such as the vendor. After operation 550, the process may then end.

Referring now to FIG. 6, an example process 600 for facilitating issuance of a payment is illustrated in accordance with various embodiments. While FIG. 6 illustrates particular operations in a particular order, in various embodiments, the operations may be combined, split into parts, and/or omitted. In various embodiments, the operations described in process 600 may be performed as one or more implementations of operation 250 of process 200. The process may begin at operation 610, where the PI 130 may request a debit from an account associated with the customer. In various embodiments, the account debited may be a credit or debit card account received in the payment request message, and/or an account previously registered with the MBP 100. Next, at decision operation 615, the PI 130 determines whether the vendor has indicated that he or she would like to receive the payment as credits against an account (such as a debit or checking account held by a bank 180 or credit card system 170) or as issuance of a check or cash (such as from a payment servicer 190. If the vendor has requested a credit, then at operation 620, the PI 130 requests that the bank 180 or credit card system 170 issue a credit toward the vendor's account, and the process ends.

If, however, the vendor has indicated that he or she would like issuance of cash or a check, then at operation 630, the PI 130 may add an amount to an internal customer account. In various embodiments, the amount added to the internal customer account may be less than the amount requested, such that the difference may be kept by an entity associated with the MBP 100 as a processing fee. In another embodiment the entire amount requested in the payment request may be added at operation 630.

Next, at decision operation 635, the PI 130 may determine whether a payment issuance threshold (hereinafter, issuance threshold or threshold) has yet been reached. As discussed above, in various embodiments, payments may not be issued until a time- or amount-based threshold has been reached. If the issuance threshold has not yet been reached, then the process may end (and the payment issued at a later time). If, however, the threshold has been reached, then at operation 640, the PI 130 may cause a payment servicer 190 to issue payment to the vendor. The process may then end.

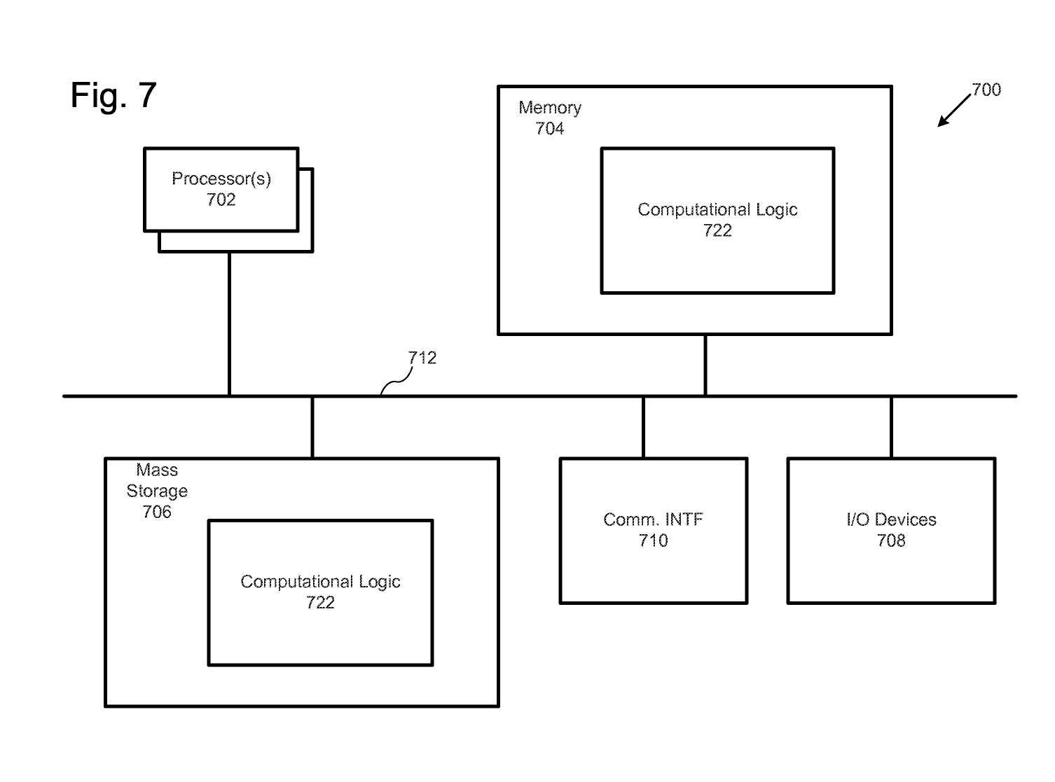

Referring now to FIG. 7, an example computer suitable for practicing various aspects of the present disclosure, including processes of FIGS. 2-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the modules shown in FIG. 1, and/or the operations associated with techniques shown in FIGS. 2-6, collectively referred to as computing logic 722. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 710-712 may vary. Their constitutions are otherwise known, and accordingly will not be further described.

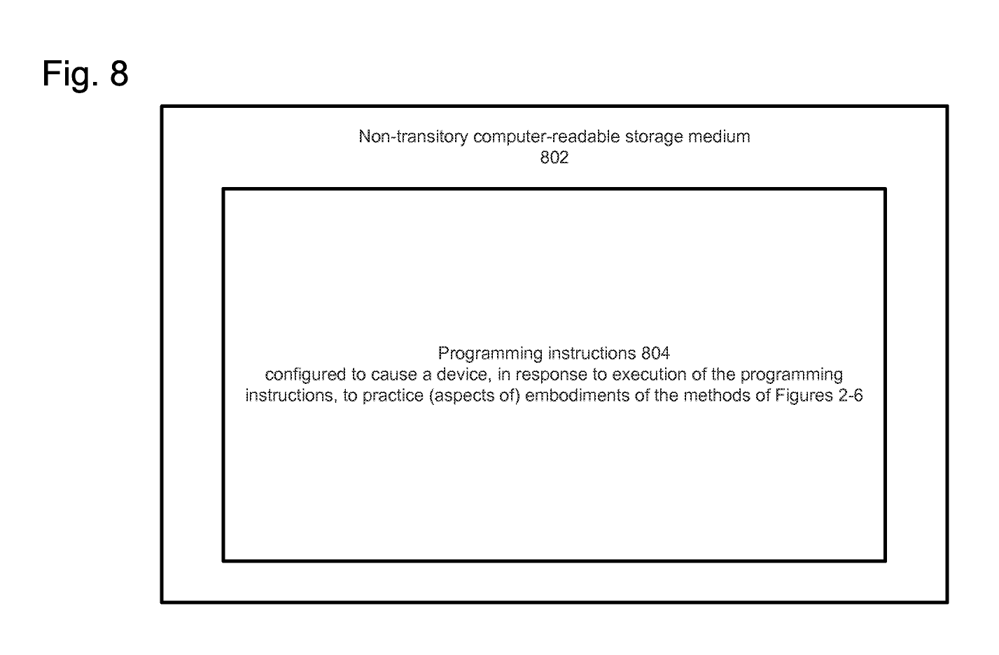

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2-6, e.g., but not limited to, to the various operations performed to perform facilitation of transactions. In alternate embodiments, programming instructions 804 may be disposed on multiple least one computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions to cause a computing system, in response to execution by the computing system, to facilitate messaging-based payments, wherein the computing system is caused to:
receive, via a messaging protocol, a request message to facilitate a first party in making a payment to a second party, wherein the request message identifies a payment amount, and identifying information for the first party;
in response to the request message, confirm that the first party authorizes payment of the payment amount to the second party; and
in response to confirmation, facilitate payment from the first party to the second party of the payment amount from an account associated with the first party.

2. The one or more computer-readable media of claim 1, wherein confirm that the first party authorizes payment comprises:
send an authorization request message to the first party; and
receive a reply message from the first party that authorizes the payment.

3. The one or more computer-readable media of claim 2, wherein:
the identifying information for the first party comprises a communication address for communication with the first party via the messaging protocol; and
send an authorization request message to the first party comprises send the authorization request message via the messaging protocol.

4. The one or more computer-readable media of claim 3, wherein the communication address comprises a communication address for a device of the first party.

5. The one or more computer-readable media of claim 1, wherein receive, via a messaging protocol, a request message comprises receive the request message via a text messaging protocol.

6. The one or more computer-readable media of claim 5, wherein receive the request message, via a text messaging protocol, comprises receive the request message from the second party.

7. The one or more computer-readable media of claim 6, wherein the second party is a vendor.

8. The one or more computer-readable media of claim 5, wherein receive the request message, via a text messaging protocol, comprises receive the request message from the first party.

9. The one or more computer-readable media of claim 1, wherein facilitate payment from the first party to the second party comprises facilitate a bank transfer from an account of the first party to an account of the second party.

10. The one or more computer-readable media of claim 1, wherein facilitate payment from the first party to the second party comprises cause payment to be made to the second party by a payment servicer.

11. The one or more computer-readable media of claim 10, wherein cause payment to be made to the second party by a payment servicer comprises cause payment to be made to the second party in response to a payment issuance threshold being reached.

12. The one or more computer-readable media of claim 11, wherein the payment issuance threshold is a time-based threshold.

13. The one or more computer-readable media of claim 11, wherein the payment issuance threshold is an amount-based threshold.

14. An apparatus to facilitate messaging-based payments, the apparatus comprising:
one or more computing processors; and
logic to operate on the one or more computing processors to:
receive, via a messaging protocol, a request message to facilitate a first party in making a payment to a second party, wherein the request message identifies a payment amount, and identifying information for the first party;
in response to the request message, confirm that the first party authorizes payment of the payment amount to the second party; and
in response to confirmation, facilitate payment from the first party to the second party of the payment amount from an account associated with the first party.

15. The apparatus of claim 14, wherein confirm that the first party authorizes payment comprises:
send an authorization request message to the first party; and
receive a reply message from the first party authorizing the payment.

16. The apparatus of claim 15, wherein:
the identifying information for the first party comprises a communication address for a device at which the first party may be communicated with via the messaging protocol; and
send an authorization request message to the first party comprises send the authorization request message to the device via the messaging protocol.

17. The apparatus of claim 14, wherein receive, via a messaging protocol, a request message comprises receive the request message via a text messaging protocol.

18. The apparatus of claim 14, wherein facilitate payment from the first party to the second party comprises facilitate a bank transfer from an account of the first party to an account of the second party.

19. The apparatus of claim 14, wherein facilitate payment from the first party to the second party comprises cause payment to be made to the second party by a payment servicer.

20. The apparatus of claim 19, wherein cause payment to be made to the second party by a payment servicer comprises cause payment to be made to the second party in response to a payment issuance threshold being reached.

21. The apparatus of claim 20, wherein the payment issuance threshold is a time-based threshold or an amount-based threshold.

22. An method for facilitating messaging-based payments, the method comprising:
receiving, by a computing system via a messaging protocol, a request message to facilitate a first party in making a payment to a second party, wherein the request message identifies a payment amount, and identifying information for the first party;
in response to the request message, confirming, by the computing system, that the first party authorizes payment of the payment amount to the second party; and
in response to confirmation, facilitating payment, by the computing system, from the first party to the second party of the payment amount from an account associated with the first party.

23. The method of claim 22, wherein confirming that the first party authorizes payment comprises:
sending an authorization request message to the first party; and
receiving a reply message from the first party authorizing the payment.

24. The method of claim 23, wherein:
the identifying information for the first party comprises a communication address for a device at which the first party may be communicated with via the messaging protocol; and
sending an authorization request message to the first party comprises sending the authorization request message to the device via the messaging protocol.

25. The method of claim 22, wherein receiving, via a messaging protocol, a request message comprises receiving the request message via a text messaging protocol.

26. The method of claim 22, wherein facilitating payment from the first party to the second party comprises facilitating a bank transfer from an account of the first party to an account of the second party.

27. The method of claim 22, wherein facilitating payment from the first party to the second party comprises causing payment to be made to the second party by a payment servicer.

28. The method of claim 27, wherein causing payment to be made to the second party by a payment servicer comprises causing payment to be made to the second party in response to a payment issuance threshold being reached.

29. The method of claim 28, wherein the payment issuance threshold is a time-based threshold or an amount-based threshold.
